(19) United States
(12) Patent Application Publication
(10) Pub. No.: US 2026/0178703 A1
(43) Pub. Date: Jun. 25, 2026

(54) GENERATION OF TRAINING DATA, GENERATION OF A DATA PROCESSING MODEL, AND VEHICLE OPERATION CONTROL

(71) Applicant: Robert Bosch GmbH, Stuttgart (DE)

(72) Inventor: Holger Wunsch, Tuebingen (DE)

(21) Appl. No.: 19/127,426

(22) PCT Filed: Jan. 9, 2024
(86) PCT No.: PCT/EP2024/050369

§ 371 Date: May 6, 2025

(30) Foreign Application Priority Data
Jan. 24, 2023 (DE) 10 2023 200 515.8

(51) Int. Cl. G06F 18/214; G06F 18/22; G06N 3/084

(52) U.S. Cl. CPC G06F 18/214; G06F 18/22; G06N 3/084

(57) ABSTRACT

A method for generating training data for a data processing model for controlling operation of a vehicle. A method for generating a data processing model, and a method for controlling operation of a vehicle, are also described.

### FIELD

The present invention relates to a method for generating training data. Furthermore, the present invention relates to a method for generating a data processing model and a method for controlling operation of a vehicle.

### BACKGROUND INFORMATION

German Patent Application No. DE 10 2011 085 976 A1 describes a device for operating a vehicle, which device sends control signals to control units depending on sensor signals from a plurality of vehicle sensors for capturing a vehicle's surrounding region.

In order to make vehicle driver assistance systems more cost-effective, the high-resolution vehicle sensors can be replaced with less expensive vehicle sensors having lower resolution. If the assistance system software is based on a machine learning process (e.g., deep neural networks), no fundamental change in the algorithms for replacing the vehicle sensors is necessary for switching to the lower-resolution sensors. However, it is crucial that sufficient data are available for training and testing the existing model used for the high-resolution sensors, in order to retrain it and adapt it to processing data from low-resolution vehicle sensors.

### SUMMARY

According to the present invention, a method for generating training data is provided. As a result, the training data for the data processing model can be provided more cost-effectively. The training data can be synthetically produced from existing high-resolution first sensor data. Thus, the data processing model can be trained more cost-effectively for processing low-resolution sensor data.

According to an example embodiment of the present invention, a method is provided for generating training data for a data processing model for controlling operation of a vehicle depending on sensor data of at least one vehicle sensor of the vehicle. The method includes:
providing first measurement data, of at least one sensor of a sensor class with which the vehicle sensor is also associated, which data capture respective environmental scenes,
providing second measurement data of at least one sensor of the sensor class, which data have a lower resolution compared to the first measurement data, in each case are temporally correlated with the first measurement data and capture the same environmental scenes as the first measurement data,
training a data conversion model using the first measurement data as input data and the second measurement data as target data,
providing further first measurement data of at least one sensor of the sensor class, which data supplement the first measurement data,
calculating output data using the data conversion model and the further first measurement data as input data and
providing the output data as training data for the data processing model.

The vehicle can be a motor-driven vehicle, preferably a motor vehicle or a two-wheeler. The vehicle can be an assistance-supported, semi-autonomous or autonomous vehicle. The control of the operation of the vehicle can involve a driver assistance system. The operation of the vehicle, in particular of the driver assistance system, can depend on input data formed from the sensor data, which are passed on to the data processing model. The data processing model can use these to calculate output data on which the operation of the vehicle, in particular the driver assistance system, depends.

The sensor data of the vehicle sensor can, if necessary, be prepared, i.e. further processed, for forming measurement data.

The environmental scene can be a capturable environmental situation of the particular sensor. The environmental scene can be an environmental situation of a region surrounding a vehicle associated with the sensor at a point in time or over a period of time. In each case, the first and second measurement data can indicate the same environmental scene in perspective. The only difference between the first and second measurement data compared to the other may be the resolution of the measurement data.

The at least one sensor that provides the first measurement data and/or the at least one sensor that provides the second measurement data can be a vehicle sensor.

The first measurement data can be provided by one or more sensors of the sensor class. The additional first measurement data can capture additional environmental scenes that differ from the environmental scenes of the first measurement data. The second measurement data can be provided by one or more sensors of the sensor class.

A sensor class, also called a sensor modality or a sensor type, comprises sensors with the same measuring principle. Radar sensors are assigned to a different sensor class than lidar sensors or cameras.

The data conversion model is preferably a computer-implemented processing algorithm. The data conversion model can be trained through deep learning. The data conversion model can include PointNet, Pointnet++, Graph Neural Network, Continuous Convolutions, Kernel-Point Convolutions or other neural networks.

The method for generating training data and/or the method for generating a data processing model is preferably a computer-implemented method.

In a preferred example embodiment of the present invention, it is advantageous if the further first measurement data have a similar or identical resolution to the first measurement data. The further first measurement data can originate from the at least one sensor capturing the first measurement data or from a further sensor of the sensor class. The additional sensor can be a vehicle sensor.

A preferred example embodiment of the present invention is advantageous in which the first and second measurement data are present as point clouds describing the respective environmental scenes. The point clouds of the second measurement data can comprise a smaller number of points than the point clouds of the first measurement data.

In a preferred example embodiment of the present invention, it is advantageous if the measurements of the first and second sensors of the same environmental scene in each case are linked to one another as associated first and second measurement data. The measurements can be carried out during at least one test drive with a vehicle having the first and second sensors, and the first and second measurement data can be prepared from these measurements.

In a preferred example embodiment of the present invention, it is provided that the data conversion model is trained by applying at least one loss function for reducing deviations between the output data of the data conversion model calculated on the basis of the first measurement data during the training and the second measurement data linked to the first measurement data as target data. As a result, unsupervised learning of the data conversion model can be carried out. The associated second measurement data can serve as target data and a benchmark for the calculation accuracy and abstraction performance of the data conversion model.

In a specific example embodiment of the present invention, it is advantageous if the output data and/or the sensor data have a similar or identical resolution to the second measurement data. As a result, the operation of the vehicle can also be reliably carried out using sensor data having lower resolution compared to the resolution used for the first measurement data.

In a preferred example embodiment of the present invention, it is provided that the sensor class comprises radar sensors, the vehicle sensor is a radar sensor and the measurement data are radar measurement data. The vehicle sensor can also be a camera, an ultrasonic sensor or a microphone. The sensor class can comprise lidar sensors, the vehicle sensor can be a lidar sensor, and the measurement data can be lidar measurement data.

According to the present invention, an example method is further provided for generating a data processing model for controlling operation of a vehicle depending on sensor data of at least one vehicle sensor of the vehicle as input data of the data processing model, which is trained at least using the output data formed by a method with at least one of the above-described features as training data. As a result, the data processing model can be trained using training data that is produced more easily and quickly.

The data processing model can be trained through deep learning. The data processing model can include PointNet, Pointnet++, Graph Neural Network, Continuous Convolutions, Kernel-Point Convolutions or other neural networks.

In a specific example embodiment of the present invention, it is advantageous if the data processing model is trained using additional second measurement data of at least one sensor of the sensor class as training data in addition to the output data. The further second measurement data can be provided by the at least one sensor that also provided the second measurement data, or by another sensor of the sensor class.

According to an example embodiment of the present invention, a method is further provided for controlling operation of a vehicle having a data processing model trained according to a method of the present invention with at least one of the above-described features depending on sensor data of at least one vehicle sensor of the vehicle as input data of the data processing model. The operation of the vehicle can include the operation of a driver assistance system, a semi-autonomous driving system and/or an autonomous driving system of the vehicle, depending on the sensor data via the calculation using the data processing model.

Furthermore, a computer program is provided which comprises machine-readable instructions executable on at least one computer, during the execution of which a method of the present invention with at least one of the previously specified features is carried out.

Furthermore, a storage unit is provided, which is designed to be machine-readable and accessible by at least one computer and on which the aforementioned computer program is stored.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 shows a method for generating training data, a method for generating a data processing model and a method for controlling operation of a vehicle, in each case in a specific example embodiment of the present invention.

FIG. 2 shows a training process of the data conversion model in a specific example embodiment of the present invention.

FIG. 3 shows a calculation process of output data using the data conversion model in a specific example embodiment of the present invention.

### DETAILED DESCRIPTION OF EXAMPLE EMBODIMENTS

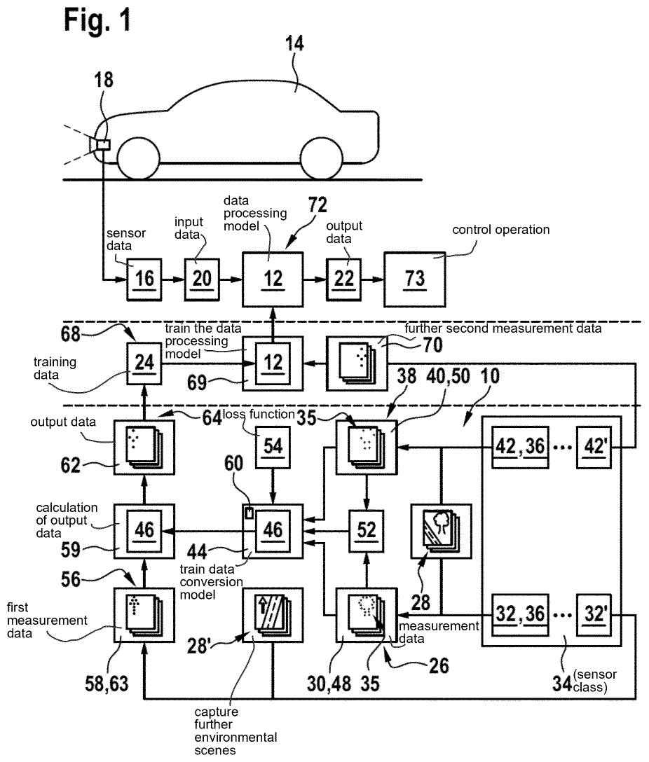

FIG. 1 shows a method for generating training data in a specific embodiment of the present invention. The method 10 for generating training data for a data processing model 12 can be carried out prior to the application of the data processing model 12 in a vehicle 14. Preferably, the method 10 is used to generate a new data processing model 12 or to adapt an existing data processing model 12.

The data processing model 12 controls operation of the vehicle 14 depending on sensor data 16 of at least one vehicle sensor 18 of the vehicle 14. Input data 20 for the data processing model 12 is formed from the sensor data 16, which data processing model then calculates output data 22 that influences the operation of the vehicle 14.

The data processing model 12 is based in particular on deep learning. The training data 24 for the data processing model 12 is generated by the following steps. Initially, first measurement data 30, of at least one sensor 32 of a sensor class 34 with which the vehicle sensor 18 is also associated, are provided 26, which data capture respective environmental scenes 28. The first measurement data 30 can be provided by one or more sensors of the sensor class 34 and are preferably point clouds 35. If the sensor 32 is, for example, a radar sensor 36, then the sensor class 34 comprises only sensors based on the same measuring principle, in this case radar sensors 36. The first measurement data 30 can, for example, depict environmental scenes 28 of vehicle environments and be radar measurement data.

Furthermore, second measurement data 40 of at least one sensor 42 of sensor class 34 are provided which have a lower resolution compared to the first measurement data 30 and in each case are temporally correlated with the first measurement data 30 and capture the same environmental scenes 28 as the first measurement data 30. If the sensor 32 is a radar sensor 36, then the sensor 42 is also a radar sensor 36, since both sensors 32, 42 are associated with the same sensor class 34. The second measurement data 40 can be provided by one or more sensors of the sensor class 34 and are preferably lower-resolution point clouds 35. In each case, the first measurement data 30 and the second measurement data 40 indicate the same environmental scene 28 in perspective. The only difference between the first and second measurement data 30, 40 in comparison to the other may be the resolution, which is greater in the first measurement data 30 than in the second measurement data 40.

For training 44 a data conversion model 46, the first measurement data 30 are used as input data 48 and the second measurement data 40 are used as target data 50. The measurements of the first and second sensors 32, 42 of the same environmental scene 28 in each case are linked to one another as associated first and second measurement data 52. The data conversion model 46 is trained by applying at least one loss function 54 for reducing deviations between the output data 60 of the data processing model 12, which output data are calculated on the basis of the first measurement data 30 during the training 44, and the second measurement data 40, associated with first measurement data 30, of the associated first and second measurement data 52 as target data 50. The data conversion model 46 is trained to calculate, from measurement data having a similar or equal resolution to the first measurement data 30, data having lower resolution that have a similar or equal resolution to the second measurement data 40.

By providing 56 further first measurement data 58 of at least one sensor 32′ of the sensor class 34, which supplement the first measurement data 30 and have the same resolution as the first measurement data 30 and capture further environmental scenes 28′, a calculation 59 of output data 62 is carried out using the data conversion model 46 and the further first measurement data 58 as input data 63. The output data 62 have a similar or identical resolution to the second measurement data 40.

Finally, the output data 62 are provided 64 as training data 24 for the data processing model 12, which can be trained using the output data 62 in order to enable operation of the vehicle 14 as a trained data processing model 12 depending on the sensor data 16.

Furthermore, FIG. 1 shows a method 68 for generating a data processing model 12 in a specific embodiment of the present invention, which is preferably carried out after the method 10 for generating training data 24, because the training 69 of the data processing model 12 is carried out at least using the training data 24 calculated by the data conversion model 46. In addition to the output data 62 of the data conversion model 46, the data processing model 12 is trained using further second measurement data 70 of at least one sensor 42′ of the sensor class 34 as training data.

Furthermore, FIG. 1 shows a method 72 for controlling 73 operation of a vehicle 14 in a specific embodiment of the present invention. The sensor data 16 are comparable or consistent with the second measurement data 40 in terms of resolution. As a result, through inference of the data processing model 12, the calculation result can be available as output data 22 more accurately and reliably.

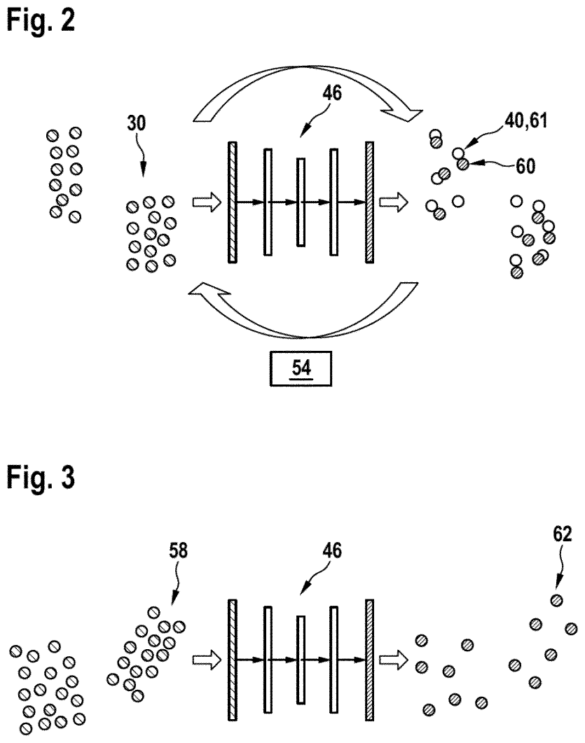

FIG. 2 shows a training process of the data conversion model in a specific embodiment of the present invention. During the training process of the data conversion model 46, the output data 60 calculated from the first measurement data 30 are iteratively compared with the second measurement data 40 as target data 50 and the deviation is back-propagated using the loss function 54.

FIG. 3 shows a calculation process of output data using the data conversion model in a specific embodiment of the present invention. The calculation process is part of the inference of the data conversion model 46. During the calculation process, the further first measurement data 58 are converted into the output data 62, which have a lower resolution than the further first measurement data 58.

1-10. (canceled)

11. A method for generating training data for a data processing model for controlling operation of a vehicle depending on sensor data of at least one vehicle sensor of the vehicle, the method comprising the following steps:
providing first measurement data, of at least one first sensor of a sensor class with which the vehicle sensor is also associated, the first measurement data capturing respective environmental scenes;
providing second measurement data of at least one second sensor of the sensor class, the second mesurement data having a lower resolution compared to the first measurement data, and in each case are temporally correlated with the first measurement data and capture the same environmental scenes as the first measurement data;
training a data conversion model using the first measurement data as input data and the second measurement data as target data;
providing further first measurement data of at least one sensor of the sensor class, the first first measurement data supplementing the first measurement data;
calculating output data using the data conversion model and the further first measurement data as input data; and
providing the output data as training data for the data processing model.

12. The method for generating training data according to claim 11, wherein the further first measurement data have a similar or identical resolution to the first measurement data.

13. The method for generating training data according to claim 11, wherein the first measurement data and the second measurement data are present as point clouds describing the respective environmental scenes.

14. The method for generating training data according to claim 11, wherein measurements of the first and second sensors of the same environmental scene in each case are linked to one another as associated first and second measurement data.

15. The method for generating training data according to claim 14, wherein the data conversion model is trained by applying at least one loss function for reducing deviations between the output data of the data conversion model calculated based on the first measurement data during the training and the second measurement data linked to the first measurement data as target data.

16. The method for generating training data according to claim 11, wherein the output data and/or the sensor data have a similar or identical resolution to the second measurement data.

17. The method for generating training data according to claim 11, wherein the sensor class includes radar sensors, the vehicle sensor is a radar sensor and the first and second measurement data are radar measurement data.

18. A method for generating a data processing model for controlling operation of a vehicle depending on sensor data of at least one vehicle sensor of the vehicle as input data of the data processing model, wherein the data processing model is trained at least using output data as training data, the output data being formed by:
providing first measurement data, of at least one first sensor of a sensor class with which the vehicle sensor is also associated, the first measurement data capturing respective environmental scenes;
providing second measurement data of at least one second sensor of the sensor class, the second mesurement data having a lower resolution compared to the first measurement data, and in each case are temporally correlated with the first measurement data and capture the same environmental scenes as the first measurement data;
training a data conversion model using the first measurement data as input data and the second measurement data as target data;
providing further first measurement data of at least one sensor of the sensor class, the first first measurement data supplementing the first measurement data;
calculating output data using the data conversion model and the further first measurement data as input data; and
providing the output data as training data for the data processing model.

19. The method for generating a data processing model according to claim 18, wherein the data processing model is trained using further second measurement data of at least one sensor of the sensor class as training data in addition to the output data.

20. A method for controlling operation of a vehicle, having a trained data processing model trained, depending on sensor data of at least one vehicle sensor of the vehicle as input data of the data processing model, the data processing model being trained by:
providing first measurement data, of at least one first sensor of a sensor class with which the vehicle sensor is also associated, the first measurement data capturing respective environmental scenes;
providing second measurement data of at least one second sensor of the sensor class, the second mesurement data having a lower resolution compared to the first measurement data, and in each case are temporally correlated with the first measurement data and capture the same environmental scenes as the first measurement data;
training a data conversion model using the first measurement data as input data and the second measurement data as target data;
providing further first measurement data of at least one sensor of the sensor class, the first first measurement data supplementing the first measurement data;
calculating output data using the data conversion model and the further first measurement data as input data; and
providing the output data as training data for the data processing model.
